(19) United States
(12) Patent Application Publication
(10) Pub. No.: US 2010/0009276 A1
(43) Pub. Date: Jan. 14, 2010

(54) DEVELOPING AGENT AND METHOD FOR PRODUCING THE SAME

(75) Inventors: Takayasu Aoki, Mishima-shi (JP); Asumi Matsumoto, Sunto-gun (JP); Takashi Urabe, Sunto-gun (JP); Tsuyoshi Itou, Izunokuni-shi (JP); Motonari Udo, Mishima-shi (JP); Satoshi Araki, Izunokuni-shi (JP); Masahiro Ikuta, Mishima-shi (JP); Takafumi Hara, Mishima-shi (JP); Yasuhito Noda, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/500,070

(22) Filed: Jul. 9, 2009

Related U.S. Application Data
(60) Provisional application No. 61/080,584, filed on Jul. 14, 2008.
(60) Provisional application No. 61/089,768, filed on Aug. 18, 2008.

(51) Int. Cl. G03G 9/08; G03G 9/087

(52) U.S. Cl. 430/108.4; 430/137.14; 430/105; 430/108.1

(57) ABSTRACT

In a method for producing a developing agent by coagulating a toner fine particle dispersion including a toner fine particle, an aqueous medium and a dispersant to obtain a toner particle, the coagulation is carried out only by pH adjustment, the dispersant is a surfactant, and a concentration of the surfactant is a concentration of not more than a critical micell concentration of the toner material dispersion.

### CROSS-REFERENCE TO RELATED APPLICATIONS

This application is based upon and claims the benefit of priority from U.S. Provisional Applications No. 61/080,584, filed on Jul. 14, 2008, and No. 61/089,768, filed on Aug. 18, 2008, the entire contents of which are incorporated herein by reference.

### TECHNICAL FIELD

The present invention relates to a developing agent for developing an electrostatic charge image or a magnetic latent image in an electrophotography process, an electrostatic printing process and the like and to a method for producing the same.

### BACKGROUND

Hitherto, a kneading and pulverization method was the main current in the method for producing an electrophotographic toner. In general, in a toner particle which is produced by the kneading and pulverization method, the shape thereof was instable, and also, it was difficult to control the composition distribution of a wax or a pigment in the toner. Also, in the kneading and pulverization method, there was a limit in making the particle size small. In the mechanical pulverization of a toner, though it includes steps of pulverization, classification and the like, the yield was lowered due to a reduction of the efficiency in classification with a decrease of the particle size, and necessary energy also increased.

On the other hand, following recent spread of the digital color mode aiming at realizing a high image quality, the needs for making the particle size of a toner small were increased. A small-particle size toner is able to increase the coverage against a medium such as paper in a low toner consumption amount and is advantageous especially for the conversion to color electrophotography. Also, from the viewpoint of enhancing transfer properties or fixability, there was demanded precise control of a toner particle, such as toner shape, particle size distribution or encapsulation. As to a production method which is satisfactory with such a demand, there is exemplified a chemical toner by a polymerization process. In case of a chemical toner, in general, the toner is worked up by preparing a fine particle dispersion of toner components and thereafter going through a coagulation step.

In general, the fine particle dispersion including a toner binder particle is stabilized as an emulsion by a dispersant such as anionic surfactants. Accordingly, in order to coagulate the fine particle dispersed in the liquid, the stabilization of the fine particle dispersion must be broken by a coagulating agent such as salts or acids. Japanese Patent No. 3107062 discloses to carry out coagulation using a water-soluble inorganic metal salt having a valence of 2 or more in the coagulation step. For example, when an inorganic water-soluble metal salt of Mg²⁺, Al^{3—}, etc. is used, the stableness of the emulsion can be easily broken to obtain a coagulated material. However, in case of a toner in the electrophotography, since the inorganic water-soluble metal salt may possibly adversely affect the electrification, washing with a large amount of wash water must be carried out. Also, there is a concern that when a resin is ionically crosslinked due to the metal salt, a gel component increases so that original characteristics of the resin are changed. On the other hand, the coagulation can also be carried out by using a pH adjustor such as acids. U.S. Pat. No. 6,531,254 discloses coagulation with sulfuric acid. However, in general, a cohesive force with an acid is weaker than that in coagulation with a salt. Therefore, when dispersibility of a fine particle dispersion is stable, a part of the fine particle dispersion remains without being coagulated because of a weak cohesive force. Thus, there was a problem that when a large amount of the acid is added, coarse particles are formed.

### SUMMARY

In view of the foregoing circumstances, the invention was made, and its object is to provide a method for producing a developing agent having excellent charge characteristic and sharp particle size distribution.

A method for producing a developing agent of the invention comprises the steps of subjecting a toner fine particle dispersion including a toner fine particle containing a binder resin and a coloring agent, an aqueous medium and a surfactant in a concentration of not more than a critical micell concentration to only pH adjustment without adding a water-soluble inorganic metal salt or an organic polymer coagulating agent thereto, thereby coagulating the toner fine particle.

Also, a developing agent of the invention comprises a toner particle in which a toner fine particle containing a binder resin and a coloring agent is coagulated in a toner fine particle dispersion including an aqueous medium and a surfactant in a concentration of not more than a critical micell concentration by only pH adjustment of the dispersion without adding a water-soluble inorganic metal salt or an organic polymer coagulating agent thereto.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a flow diagram showing an example of a method for producing a developing agent of the invention.

FIG. 2 is a flow diagram showing a modification example of the method for producing a developing agent shown in FIG. 1.

FIG. 3 is a graph showing a relationship between a concentration and a surface tension of a surfactant in a dispersion.

FIG. 4 is a flow diagram showing a method for producing a developing agent according to the Examples of the invention.

### DETAILED DESCRIPTION

The method for producing a developing agent of the invention comprises the steps of coagulating a toner fine particle in a toner fine particle dispersion including a toner fine particle, an aqueous medium and a dispersant to obtain a toner particle; and washing the obtained toner particle, wherein

the used dispersant is a surfactant; a concentration of the surfactant is a concentration of not more than a critical micell concentration of the toner material dispersion; and the coagulation is carried out only by pH adjustment of the dispersion without using a water-soluble inorganic metal salt or an organic polymer coagulating agent.

Also, the developing agent of the invention is a developing agent obtained by using the foregoing method.

According to the invention, by using a surfactant as the dispersant and adjusting a concentration of the surfactant in the dispersion at a concentration at which the fine particle of the toner material can be thoroughly dispersed and which is not more than a critical micell concentration, the coagulation of the fine particle of the toner material can be stably carried out only by the addition of an acid, and uncoagulation and the formation of coarse particles are not caused. Also, in the washing step of the toner particle obtained by coagulation, it is possible to remarkably reduce the amount of wash water to be used. Furthermore, according to the invention, it is not necessary to jointly use a metal salt as the coagulating agent other than the acid. Therefore, the invention is free from changes in charge properties of the developing agent or changes in characteristics of the toner material, for example, a binder resin, as seen in developing agents using a metal salt. For those reasons, by adopting the invention, a developing agent having excellent charge characteristic and sharp particles size distribution is obtainable.

The invention is hereunder described in more detail with reference to the accompanying drawings.

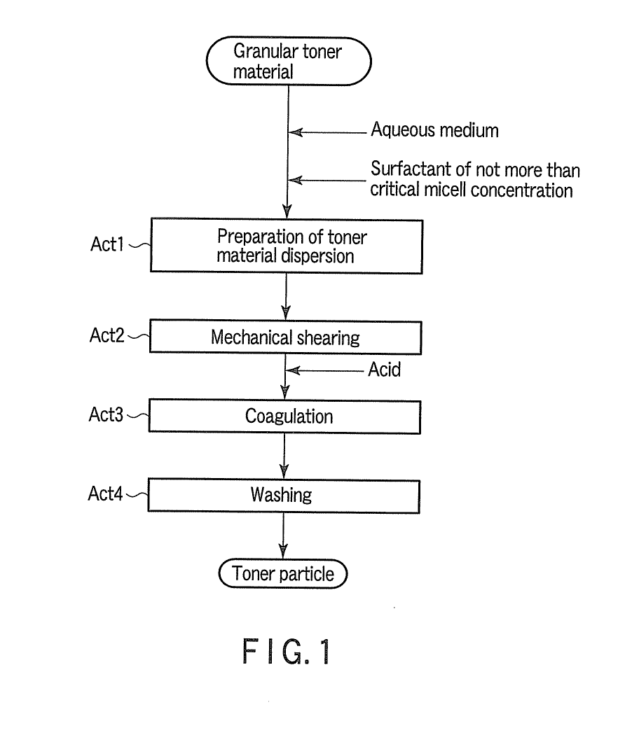

FIG. 1 is a flow diagram showing an example of the method for producing a developing agent of the invention.

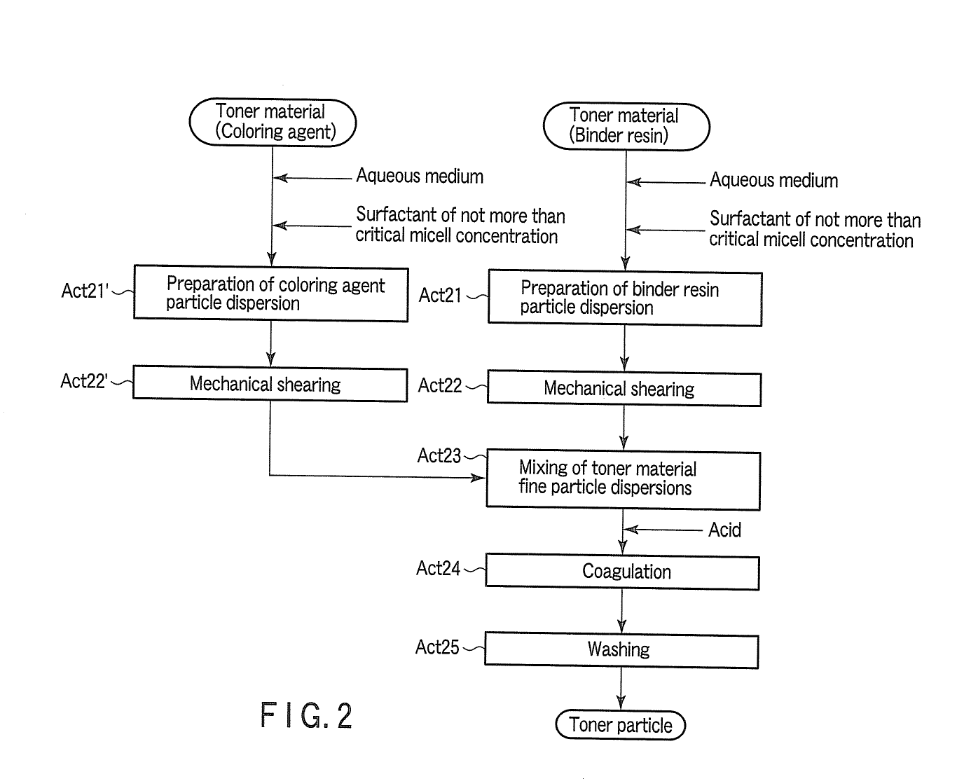

FIG. 2 is a flow diagram showing a modification example of the method for producing a developing agent shown in FIG. 1.

First of all, a binder resin particle and a coloring agent particle, or a particle of a mixture of a binder resin and a coloring agent is prepared as a granular toner material.

The particle of a mixture can be, for example, prepared by a so-called pulverization method by the steps of melting and kneading a binder resin and a coloring agent and pulverizing the obtained kneaded material.

Subsequently, an aqueous medium and a surfactant in a concentration of not more than a critical micell concentration are added to the toner material, thereby preparing a toner material dispersion (Act 1).

When the particle of a mixture of a binder resin and a coloring agent is used, a single toner material dispersion is prepared.

On the other hand, when the binder resin particle and the coloring agent particle are used, toner material dispersions can be separately prepared (Act 21 and Act 21′).

Subsequently, the toner material dispersion is provided for mechanical shearing (Act 2).

According to this, the particle in the toner material dispersion is further atomized to form a fine particle having a particle size smaller than that of this particle.

When the particle of a mixture of a binder resin and a coloring agent is used, the toner material dispersion is singly provided for mechanical shearing.

On the other hand, when the binder resin particle dispersion and the coloring agent particle dispersion are used, these dispersions can be separately provided for mechanical shearing (Act 22 and Act 22′).

An acid is further added as a coagulating agent to this fine particle-including dispersion to coagulate the fine particle, which is then stabilized by, for example, heating or other means, thereby forming a toner particle (Act 3).

When the particle of a mixture of a binder resin and a coloring agent is used, the toner material dispersion is singly provided for coagulation. When the binder resin particle dispersion and the coloring agent particle dispersion are used, the both dispersions are mixed (Act 23), and the mixture can be provided for coagulation (Act 24).

The toner particle is washed to remove the acid and the surfactant (Act 4 and Act 25).

Thereafter, drying is carried out to obtain a final toner particle.

By arbitrarily adding an additive onto the obtained toner particle surface for the purpose of adjusting fluidity or charge properties, a toner can be obtained.

Also, the toner can be mixed with a carrier or the like.

The toner material which is used in the invention is at least a binder resin and a coloring agent.

As other toner materials, a release agent such as waxes and a charge controlling agent can be arbitrarily used.

In order to stably produce the dispersion in an amount of the surfactant in not more than a critical micell concentration, a high-pressure homogenizer type atomizer can be used as a device capable of giving mechanical shearing.

Also, among acids, in particular, acetic anhydride is gradually decomposed into acetic acid in water. Therefore, the use of acetic anhydride is convenient for controlling a coagulation rate.

### (Critical Micell Concentration)

The micell as referred to herein means a structure in which molecules of the surfactant are arranged in a layered state such that the surfactant is stabilized in water. With respect to the critical micell concentration (CMC), when the surfactant is gradually added, a minimum concentration of the surfactant at which a micell is formed is called “critical micell concentration”.

In general, an emulsion dispersion which is stabilized with a surfactant can be kept at a concentration of the surfactant of the critical micell concentration or more. However, in the invention, a desired particle size is obtained by producing an emulsion dispersion of the toner material fine particle and then intentionally breaking the emulsion stability in the coagulation step. When a degree of dispersion stability of the emulsion dispersion of the toner material fine particle is high, it is difficult to coagulate the toner material fine particle only by pH control with an acid. Then, as a result of extensive and intensive investigations, the present inventors found that when the critical micell concentration of a system in a state that the toner material is added as a solids content is measured as an index of the degree of dispersion stability of the toner material fine particle dispersion which is suitable for the coagulation with an acid, if the concentration of the surfactant is not more than the critical micell concentration, the coagulation with an acid can be stably carried out.

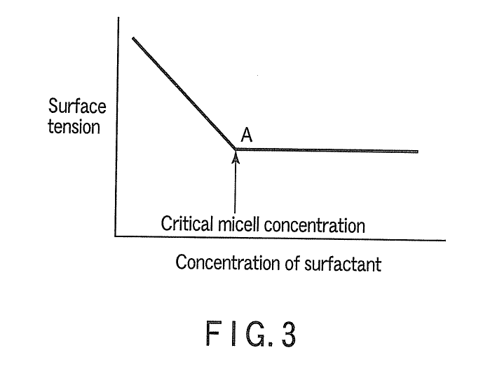

FIG. 3 is a graph showing a relationship between a concentration and a surface tension of the surfactant in the dispersion.

In the measurement of the critical micell concentration regarding the concentration of the surfactant, a toner material dispersion is prepared while gradually increasing the amount of the surfactant; a surface tension of the dispersion is measured; and a concentration of the surfactant when the surface tension reaches a point A which is constant even by increasing the amount of the surfactant as shown in the graph of FIG. 3 is the critical micell concentration.

Also, the surfactant which is used in the invention can be added in a concentration of the critical micell concentration or more to the aqueous medium not containing the toner material as a solids content. When the amount of the surfactant is a concentration of the critical micell concentration or more relative to the aqueous medium, the toner material can be thoroughly wetted with this aqueous medium.

In view of the foregoing fact, the concentration of the surfactant which is used in the invention can be regulated at a critical micell concentration of the aqueous medium or more and not more than a critical micell concentration of the toner material dispersion.

### (Toner Binder Resin: Polyester Resin)

In the invention, a polyester based resin obtained by esterification of a dicarboxylic acid component and a diol component and subsequent polycondensation is desirable as the resin to be used as the toner binder. Examples of the acid component include aromatic dicarboxylic acids, for example, terephthalic acid, phthalic acid, isophthalic acid, etc.; and aliphatic dicarboxylic acids, for example, fumaric acid, maleic acid, succinic acid, adipic acid, sebacic acid, glutaric acid, pimelic acid, oxalic acid, malonic acid, citraconic acid, itaconic acid, etc.

Examples of the alcohol component include aliphatic diols, for example, ethylene glycol, propylene glycol, 1,4-butanediol, 1,3-butanediol, 1,5-pentanediol, 1,6-hexanediol, neopentyl glycol, trimethylene glycol, trimethylolpropane, pentaerythritol, etc.; alicyclic diols, for example, 1,4-cyclohexanediol, 1,4-cyclohexanedimethanol, etc.; ethylene oxide or propylene oxide adducts, for example, bisphenol A, etc.

The foregoing polyester component may be converted so as to have a crosslinked structure by using a trihydric or polyhydric carboxylic acid or polyhydric alcohol component, for example, 1,2,4-benzenetricarboxylic acid (trimellitic acid), glycerin, etc.

A mixture of two or more kinds of polyester resins having a different composition from each other may be used.

A glass transition temperature of the polyester resin is desirably 45° C. or higher and not higher than 70° C., and more desirably 50° C. or higher and not higher than 65° C. When the glass transition temperature is lower than 45° C., the heat resistant storage stability of the toner is deteriorated, whereas when it is higher than 70° C., the low-temperature fixability is deteriorated. A weight average molecular weight Mw of the polyester resin is desirably 5,000 or more and not more than 50,000, and more desirably 8,000 or more and not more than 20,000.

### (Release Agent Component)

In the invention, a release agent component can be blended in the binder resin. Examples of the release agent include aliphatic hydrocarbon based waxes, for example, low-molecular weight polyethylene, low-molecular weight polypropylene, polyolefin copolymers, polyolefin waxes, paraffin waxes, Fischer-Tropsch wax, etc. and modifications thereof; vegetable waxes, for example, candelilla wax, carnauba wax, Japan wax, jojoba wax, rice wax, etc.; animal waxes, for example, bees wax, lanolin, whale wax, etc.; mineral waxes, for example, montan wax, ozokerite, cerecin, etc.; fatty acid amides, for example, linoleic acid amide, oleic acid amide, lauric acid amide, etc.; and silicone based waxes.

As the release agent which is used in the invention, those having an ester bond of a component composed of an alcohol component and a carboxylic acid component are preferable. Examples of the alcohol component include higher alcohols; and examples of the carboxylic acid component include saturated fatty acids having a linear alkyl group, unsaturated fatty acids, for example, monoenic acid, polyenic acid, etc., and hydroxy fatty acids. Also, examples of the unsaturated polyhydric carboxylic acid include maleic acid, fumaric acid, citraconic acid and itaconic acid. Also, anhydrides of these unsaturated polyhydric carboxylic acids may be used. In the carboxylic acid component, those having the foregoing unsaturated polyhydric carboxylic acid component and anhydrides thereof are more preferable.

A softening point of the release agent is desirably from 60° C. to 120° C., and more desirably from 70° C. to 110° C. from the viewpoint of low-temperature fixability.

### (Coloring Agent)

As the coloring agent, carbon black and organic or inorganic pigments or dyes can be used. The coloring agent is not particularly limited. Examples of the carbon black include acetylene black, furnace black, thermal black, channel black and ketjen black. Also, examples of the pigment or dye include Fast Yellow G, Benzidine Yellow, Indo Fast Orange, Irgazin Red, Naphtholazo, Carmine FB, Permanent Bordeaux FRR, Pigment Orange R, Lithol Red 2G, Lake Red C, Rhodamine FB, Rhodamine B Lake, Phthalocyanine Blue, Pigment Blue, Brilliant Green B, Phthalocyanine Green and quinacridone. These materials can be used singly or in admixture.

### (Charge Controlling Agent)

In the invention, a charge controlling agent can be blended for the purpose of controlling a triboelectrostatic charge quantity.

As the charge controlling agent, a metal-containing azo compound can be used. As the metal element, complexes or complex salts of iron, cobalt or chromium, or mixtures thereof can be used. Also, a metal-containing salicylic acid derivative compound can be used as the charge controlling agent. As the metal element, complexes or complex salts of zirconium, zinc, chromium or boron, or mixtures thereof can be used.

### (Additive)

In the invention, in order to regulate fluidity or charge properties against the toner particle, an inorganic fine particle can be added onto the toner particle surface in an amount of from 0.01 to 20% by weight relative to the whole weight of the toner particle. As such an inorganic fine particle, silica, titania, alumina, strontium titanate, tin oxide and the like can be used singly or in admixture of two or more kinds thereof. From the viewpoint of enhancing the environmental stability, it is preferred to use an inorganic fine particle which is subjected to a surface treatment with a hydrophobic agent. Also, in addition to such an inorganic oxide, a resin fine particle of not larger than 1 μm, for example, a resin such as a polysiloxane resin may be externally added for the purpose of enhancing cleaning properties.

### (Surfactant)

In the invention, a surfactant is used in atomizing the resin, the coloring agent and the wax.

Examples of an anionic surfactant include sulfonic acid salts, for example, alkylbenzenesulfonic acid salts, alkylnaphthalenesulfonic acid salts, alkyldiphenyl ether disulfonic acid salts, alkanesulfonic acid salts, etc.; fatty acid salts, for example, oleic acid salts, stearic acid salts, palmitic acid salts, etc.; sulfuric acid ester salts, for example, a lauryl sulfate salt, a lauryl ether sulfate salt, etc.; polyoxyethylene alkyl ether carboxylic acid salts; and alkenylsuccinic acid salts.

Examples of a cationic surfactant include amine salts, for example, laurylamine salts, oleylamine salts, stearylamine salts, etc.; and quaternary ammonium salts, for example, a lauryltrimethylammonium salt, a stearyltrimethylammonium salt, a distearyldimethylammonium salt, an alkylbenzyldimethylammonium salt, etc.

Examples of a nonionic surfactant include polyoxyethylene alkyl ethers, for example, polyoxyethylene lauryl ether, polyoxyethylene stearyl ether, polyoxyethylene myristyl ether, etc.; polyoxyalkylene alkyl ethers, for example, polyoxyethylene alkylene alkyl ethers, polyoxyethylene polyoxypropylene glycol, etc.; and sorbitan fatty acid esters, for example, sorbitan monolaurate, sorbitan monopalmitate, sorbitan monostearate, etc.

### (Acid to be Used as a Coagulating Agent)

In the invention, for the purpose of adjusting the pH, an acid is added as a coagulating agent to the dispersion including a fine particle of the toner material at the time of coagulation. As such an acid, for example, hydrochloric acid, sulfuric acid, nitric acid, phosphoric acid, acetic acid, acetic anhydride, citric acid, etc. can be used. Of these acids, acetic anhydride is especially preferable because it is gradually decomposed into acetic acid upon reacting with water, and a pH change is mild. Also, the higher the water temperature, the faster the decomposition rate of acetic anhydride, and therefore, the pH can also be controlled by the water temperature. When acetic anhydride is decomposed in water, a homogenizer is generally used. The decomposition rate of acetic anhydride is also changeable by a rotation speed of the homogenizer so that the pH can be controlled.

### (Device for Giving Mechanical Shearing to Particle Dispersion)

In the invention, the toner component including a polyester resin is produced by mechanical shearing. Examples of a device for giving mechanical shearing include medium-free stirrers, for example, ULTRA TURRAX (manufactured by IKA Japan K.K.), T.K. AUTO HOMO MIXER (manufactured by PRIMIX Corporation), T.K. PIPELINE HOMO MIXER (manufactured by PRIMIX Corporation), T.K. FILMICS (manufactured by PRIMIX Corporation), CLEAR MIX (manufactured by MTECHNIQUE Co., Ltd.), CLEAR SS5 (manufactured by MTECHNIQUE Co., Ltd.), CAVITRON (manufactured by EUROTEC, Ltd.), FINE FLOW MILL (manufactured by Pacific Machinery & Engineering Co., Ltd.), etc.; and high-pressure homogenizer types, for example, a Manton-Gaulin type high-pressure homogenizer (manufactured by Niro Soavi), MICROFLUIDIZER (manufactured by Mizuho Industrial Co., Ltd.), NANO-MIZER (manufactured by Nano-Mizer), ALTIMIZER (manufactured by Sugino Machine Limited), GENUS PY (manufactured by Hakusui Chemical Industries, Ltd.), NANO3000 (manufactured by Biryu Co., Ltd.), etc. From the standpoint of the purpose of minimizing the amount of the surfactant relative to the toner solids content, high-pressure homogenizer types are especially preferable.

### (Neutralizing Agent in Carrying Out Mechanical Shearing)

The dispersion is produced by using the foregoing production apparatus. A neutralizing agent can be used in carrying out mechanical shearing. Examples of the neutralizing agent include alkali metal hydroxides, for example, sodium hydroxide, potassium hydroxide, lithium hydroxide, etc.; and amines, for example, ammonia water, methylamine, dimethylamine, triethylamine, ethylamine, dimethylaminoethanol, diethylaminoethanol, diethanolamine, triethanolamine, morpholine, etc. Of these, monovalent alkali metal hydroxides or amines can be preferably used in view of a neutralization effect and easiness of availability.

### (Mixing of Binder Resin, Coloring Agent, Wax and Charge Controlling Agent, Etc.)

In the invention, with respect to mixing of the binder resin, the coloring agent, the wax and the charge controlling agent, etc., fine particle dispersions of these materials may be individually produced by using a device for giving mechanical shearing, mixed and then coagulated. Alternatively, a desired material may be produced by melting and kneading the binder resin, the coloring agent, the wax and the charge controlling agent, etc. by using a melt kneader, providing a pulverized material thereof for a device for giving mechanical shearing to produce a fine particle dispersion and then coagulating it.

In the invention, when a mixture including at least a resin and a pigment is kneaded by using a melt kneader and used, there is no particular limitation with regard to the melt kneader. Examples of the melt kneader include a single-screw extruder, a twin-screw extruder, a pressure kneader, a Banbury mixer and a Brabender mixer. Specific examples thereof include FCM (manufactured by Kobe Steel, Ltd.), NCM (manufactured by Kobe Steel, Ltd.), LCM (manufactured by Kobe Steel, Ltd.), ACM (manufactured by Kobe Steel, Ltd.), KTX (manufactured by Kobe Steel, Ltd.), GT (manufactured by Ikegai, Ltd.), PCM (manufactured by Ikegai, Ltd.), TEX (manufactured by The Japan Steel Works, Ltd.), TEM (manufactured by Toshiba Machine Co., Ltd.), ZSK (manufactured by Warner K.K.) and KNEADEX (manufactured by Mitsui Mining Co., Ltd.).

### (Stirring Blade in Coagulation Vessel)

In the invention, a coagulation vessel which can be used for carrying out the coagulation is provided with a stirring blade. Though this stirring blade is not particularly limited, examples of a general stirring blade include a paddle blade, a turbine blade, an anchor blade, a Pfaudler blade, a bull margin blade and an impeller blade. Also, examples of a high-viscosity solution type include a Maxblend blade (Sumitomo Heavy Industries, Ltd.), a double helical blade, a Fullzone blade (Kobelco Eco-Solutions Co., Ltd.), a Logborn blade (Kobelco Eco-Solutions Co., Ltd.) and a Hi-F mixer blade (Soken Chemical & Engineering Co., Ltd.).

### (Coagulation Method)

In the invention, in order to coagulate the fine particle in the dispersion, a coagulating agent is fed into the toner dispersion while stirring by a stirring blade. As the coagulating agent, one prepared by dispersing a dilute solution of an acid in water by using a homogenizer, etc. is preferable. A feed temperature of the coagulating agent is preferably not higher than a glass transition point temperature of the toner resin, i.e., from 20° C. to 50° C. When the coagulating agent is fed at a temperature higher than the glass transition point temperature of the resin, there is a concern that coarse particles are formed simultaneously with the dropwise addition of the coagulating agent. When the feed temperature of the coagulating agent is lower than 20° C., cooling is necessary so that the efficiency is poor. It is preferable that feed of the coagulating agent solution is carried out by continuous addition by using a pump, etc. After finishing the feed of the coagulating agent solution, the temperature is increased. Finally, the temperature is increased to a temperature until the toner coagulation is thoroughly fused. An ultimate temperature is preferably from 70° C. to 90° C.

The invention is hereunder specifically described with reference to the following Examples.

### EXAMPLES

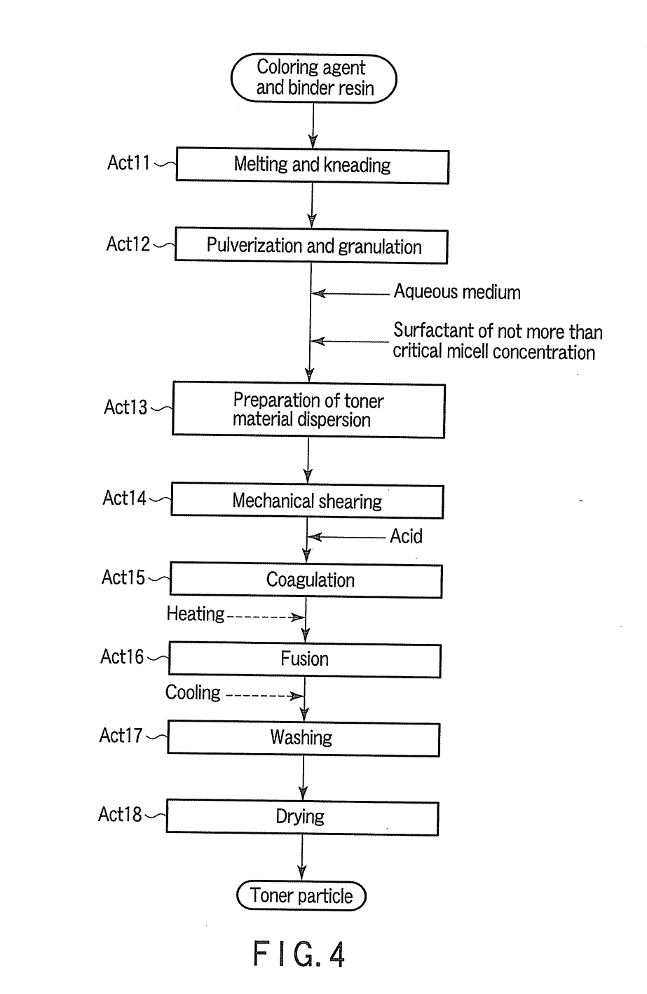

FIG. 4 is a flow diagram showing a method for producing a developing agent according to the Examples of the invention.

### Production of Amorphous Polyester Resin

39 parts of terephthalic acid, 61 parts of an ethylene oxide compound of bisphenol A and 0.2 parts of dibutyltin were thrown into an esterification reaction vessel and subjected to a polycondensation reaction at 260° C. and 50 kPa for 5 hours under a nitrogen atmosphere, thereby obtaining a polyester resin. A glass transition temperature Tg was 60° C., a softening point was 110° C., and a weight average molecular weight was 12,000.

### Production of Toner Material Fine Particle Dispersion 1

90 parts by weight, in terms of a solids content, of the foregoing amorphous polyester resin, 5 parts by weight of rice wax as a release agent and 5 parts by weight of a cyan pigment were kneaded in a twin-screw kneader (Act 11), and the obtained kneaded material was pulverized to obtain a coarsely pulverized material of a toner (Act 12). 100 parts of this coarsely pulverized material of a toner, 1.0 part of an anionic surfactant, NEOGEN R (manufactured by Dai-ichi Kogyo Seiyaku Co., Ltd.) as a surfactant, 2.1 parts of dimethylaminoethanol (DMAE) and 330 parts of deionized water were added to prepare a toner material dispersion (Act 13).

The toner material dispersion was provided in a high-pressure type homogenizer and atomized under a condition at 160° C. and 150 MPa (Act 14). Then, the atomized material was cooled to ordinary temperature to produce a dispersion 1. A volume average particle size of the dispersion was measured by a laser diffraction particle size distribution analyzer (SALD-7000, manufactured by Shimadzu Corporation). As a result, it was found to be 0.52 μm. Also, dispersions in which the amount of NEOGEN R was changed from 0.5 parts to 5.0 parts at intervals of 0.5 parts were prepared in the same manner. A surface tension of each of the thus prepared dispersions was measured, and a critical micell concentration (CMC) was determined in the manner shown in FIG. 3. As a result, it was noted that the amount of the surfactant was 2.5 parts relative to the toner solids content.

### Example 1

100 parts of the dispersion 1 (solids concentration: 40%) and 100 parts of deionized water were charged in a glass-made separable flask equipped with a stirrer. A hydrochloric acid aqueous solution was continuously added dropwise as a coagulating agent at a temperature within the flask of 30° C. by using a pump while rotating a paddle type stirring blade at 700 rpm (Act 15). Hydrochloric acid was charged in an amount of 0.30 parts by weight relative to the toner solids content. Then, the temperature was increased to 85° C. over 3 hours and then kept at 85° C. for one hour, thereby fusing the toner particle (Act 16). The obtained toner particle had a volume average particle size of 5.2 μm and a CV value expressing the distribution of 20%.

After cooling, the obtained colored particle was washed with wash water by a filter until a conductivity of the wash water reached 0.5 μS/cm (Act 17). At that time, the amount of wash water was 30 times the toner solids content. Then, the resulting particle was dried by a vacuum dryer until the water content reached 0.3% by weight (Act 18). The obtained toner particle had a volume average particle size of 5.2 μm, and coarse particles of 12 μm or more in volume average accounted for 0.4% of the whole. After drying, 2 parts by weight of hydrophobic silica (RX-200, manufactured by Nippon Aerosil Co., Ltd.) and 0.5 parts by weight of titanium oxide (STT-30EHJ, manufactured by Titan Kogyo K.K.) were deposited on the colored particle surface, whereby a desired electrophotographic toner could be obtained. A carrier was mixed with 5% by weight of the obtained toner, and a charge quantity was measured by a blow-off electrification measuring device (TB-220, manufactured by Toshiba Chemical Corporation). As a result, the charge quantity was found to be −35 μC/g.

### Example 2

By using the dispersion 1, coagulation and fusion were carried out in the same manner as in Example 1, except for collectively feeding 0.35 parts by weight relative to the toner solids content of acetic anhydride dispersed in water at 30° C. in coagulation by the homogenizer at a temperature within the flask of 30° C. A toner obtained after the fusion had a volume average particle size of 6.5 μm and a CV value of 18%. After cooling, the obtained colored particle was washed with wash water by a filter until a conductivity of the wash water reached 0.5 μS/cm. At that time, the amount of wash water was 25 times the toner solids content. Then, the resulting particle was dried by a vacuum dryer until the water content reached 0.3% by weight. The obtained toner particle had a volume average particle size of 6.5 μm, and coarse particles of 12 μm or more in volume average accounted for 0.2% of the whole. A charge quantity was measured in the same manner as in Example 1. As a result, it was found to be −27 μC/g.

### Example 3

### Production of Toner Material Fine Particle Dispersion 2

A toner dispersion was prepared in the same manner as in the preparation method of the dispersion 1, except for changing the neutralizing agent from dimethylaminoethanol to 0.9 parts of sodium hydroxide. The dispersion had a volume average particle size of 0.65 μm.

By using the dispersion 2, coagulation and fusion were carried out in the same manner as in Example 1, except for changing the amount of hydrochloric acid in the coagulation to 0.45 parts by weight relative to the toner solids content. A toner obtained after the fusion had a volume average particle size of 4.5 μm and a CV value of 24%. After cooling, the obtained colored particle was washed with wash water by a filter until a conductivity of the wash water reached 0.5 μS/cm. At that time, the amount of wash water was 26 times the toner solids content. Then, the resulting particle was dried by a vacuum dryer until the water content reached 0.3% by weight. The obtained toner particle had a volume average particle size of 4.5 μm, and coarse particles of 12 μm or more in volume average accounted for 0.3% of the whole. A charge quantity was measured in the same manner as in Example 1. As a result, it was found to be −40 μC/g.

### Comparative Example 1

### Production of Toner Material Fine Particle Dispersion 3

A toner dispersion was prepared in the same manner as in the preparation method of the atomized dispersion 1, except for adding 3.5 parts of NEOGEN R based on 100 parts of the toner coarsely pulverized material. The dispersion had a volume average particle size of 0.37 μm.

By using the dispersion 3, coagulation and fusion were carried out in the same manner as in Example 1, except for changing the amount of hydrochloric acid in the coagulation to 0.40 parts by weight relative to the toner solids content. When the fusion was finished, a supernatant became white and cloudy because of the existence of an uncoagulated component. A toner obtained after the fusion had a volume average particle size of 6.5 μm and a CV value of 48%. Also, coarse particles of 12 μm or more in volume average existed in an amount of 7% of the whole.

### Comparative Example 2

### Production of Toner Material Fine Particle Dispersion 4

A toner dispersion was prepared in the same manner as in the preparation method of the atomized dispersion 1, except for adding 4.5 parts of NEOGEN R based on 100 parts of the toner coarsely pulverized material. The dispersion had a volume average particle size of 0.26 μm.

By using the dispersion 4, coagulation and fusion were carried out in the same manner as in Example 1, except for changing the amount of hydrochloric acid in the coagulation to 0.50 parts by weight relative to the toner solids content. When the fusion was finished, a supernatant became white and cloudy because of the existence of an uncoagulated component. A toner obtained after the fusion had a volume average particle size of 7.3 μm and a CV value of 62%. Also, coarse particles of 12 μm or more in volume average existed in an amount of 9.5% of the whole.

### Comparative Example 3

By using the dispersion 1, an aluminum sulfate aqueous solution was continuously added dropwise as a coagulating agent in an amount of 2.5 parts by weight relative to the toner solids content at 30° C. When the temperature reached 60° C., for the purpose of preventing unification of particles from occurring, an anionic surfactant PELEX SS-L was added in an amount of 5.0 parts relative to the toner solids content. Then, the temperature was increased to 90° C. and kept at 90° C. for one hour. A toner obtained after the fusion had a volume average particle size of 5.8 μm and a CV value of 28%. After cooling, the obtained colored particle was washed with wash water by a filter until a conductivity of the wash water reached 0.5 μS/cm. At that time, the amount of wash water was 300 times the toner solids content. Then, the resulting particle was dried by a vacuum dryer until the water content reached 0.3% by weight. The obtained toner particle had a volume average particle size of 5.8 μm, and coarse particles of 12 μm or more in volume average accounted for 1.2% of the whole. A charge quantity was measured in the same manner as in Example 1. As a result, it was found to be −12 μC/g.

By taking such a configuration, an electrophotographic toner containing low impurities and having excellent charge characteristic and sharp particle size distribution can be produced.

The obtained results are shown in the following Table 1.

TABLE 1

| | | | | Comparative | Comparative | Comparative |
|---|---|---|---|---|---|---|
| | Example 1 | Example 2 | Example 3 | Example 1 | Example 2 | Example 3 |
| Atomized solution | Atomized | Atomized | Atomized | Atomized | Atomized | Atomized |
| | solution 1 | solution 1 | solution 2 | solution 3 | solution 4 | solution 1 |
| Neutralizing agent | DMAE | → | NaOH | DMAE | → | DMAE |
| Surfactant of atomized solution | 0.4 | 0.4 | 0.4 | 1.4 | 1.8 | 0.4 |
| Concentration/CMC concentration | (1.0/2.5) | | | (3.5/2.5) | (4.5/2.5) | |
| Coagulating agent | Hydrochloric | Acetic | Hydrochloric | Hydrochloric | Hydrochloric | Al₂(SO₄)₃ |
| | acid | anhydride | acid | acid | acid | |
| Amount (relative to solids content: %) | 0.30 | 0.35 | 0.45 | 0.40 | 0.50 | 2.5 |
| Volume average particle size (μm) | 5.2 | 6.5 | 4.5 | 6.5 | 7.3 | 5.8 |
| Coarse particles of 12 μm or more (%) | 0.4 | 0.2 | 0.3 | 7 | 9.5 | 1.2 |
| CV value (%) | 20 | 18 | 24 | 48 | 62 | 28 |
| Charge quantity (μC/g) | −35 | −27 | −40 | — | — | −12 |
| Amount of wash water (times) | 30 | 25 | 26 | — | — | 300 |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for producing a developing agent comprising subjecting a toner fine particle dispersion including a toner fine particle containing a binder resin and a coloring agent, an aqueous medium and a surfactant in a concentration of not more than a critical micell concentration to only pH adjustment without adding a water-soluble inorganic metal salt or an organic polymer coagulating agent thereto, to coagulate the toner fine particle.

2. The method according to claim 1, wherein the pH adjustment is carried out by the addition of an acid.

3. The method according to claim 2, wherein the acid is at least one member selected from the group consisting of hydrochloric acid, sulfuric acid, nitric acid, phosphoric acid, acetic acid, acetic anhydride and citric acid.

4. The method according to claim 3, wherein the acid is acetic anhydride.

5. The method according to claim 1, wherein the toner fine particle is formed by providing a toner material dispersion including a granular toner material mixture containing a binder resin and a coloring agent, an aqueous medium and a surfactant in a concentration of not more than a critical micell concentration for mechanical shearing; and atomizing the granular mixture to prepare a dispersion including a fine particle having a particle size smaller than a particle size of the granular mixture.

6. The method according to claim 5, wherein the granular toner material mixture is formed by melting and kneading the binder resin and the coloring agent; and pulverizing the obtained kneaded material.

7. The method according to claim 5, wherein the mechanical shearing is provided by passing the toner material dispersion through a high-pressure homogenizer.

8. The method according to claim 1, wherein the concentration of the surfactant is a critical micell concentration of the aqueous medium or more and not more than a critical micell concentration of the toner material dispersion.

9. A developing agent comprising a toner particle in which a toner fine particle containing a binder resin and a coloring agent is coagulated in a toner fine particle dispersion including an aqueous medium and a surfactant in a concentration of not more than a critical micell concentration by only pH adjustment of the dispersion without adding a water-soluble inorganic metal salt or an organic polymer coagulating agent thereto.

10. The developing agent according to claim 9, wherein the pH adjustment is carried out by the addition of an acid.

11. The developing agent according to claim 10, wherein the acid is at least one member selected from the group consisting of hydrochloric acid, sulfuric acid, nitric acid, phosphoric acid, acetic acid, acetic anhydride and citric acid.

12. The developing agent according to claim 11, wherein the acid is acetic anhydride.

13. The developing agent according to claim 9, wherein the toner fine particle is formed by providing a toner material dispersion including a granular toner material mixture containing a binder resin and a coloring agent, an aqueous medium and a surfactant in a concentration of not more than a critical micell concentration for mechanical shearing; and atomizing the granular mixture to prepare a dispersion including a fine particle having a particle size smaller than a particle size of the granular mixture.

14. The developing agent according to claim 13, wherein the granular toner material mixture is formed by melting and kneading the binder resin and the coloring agent; and pulverizing the obtained kneaded material.

15. The developing agent according to claim 13, wherein the mechanical shearing is provided by passing the toner material dispersion through a high-pressure homogenizer.

16. The developing agent according to claim 9, wherein the concentration of the surfactant is a critical micell concentration of the aqueous medium or more and not more than a critical micell concentration of the toner material dispersion.
